(19) United States
(12) Patent Application Publication
(10) Pub. No.: US 2008/0255753 A1
(43) Pub. Date: Oct. 16, 2008

(54) Method and System for Automatically Adjusting Electronic Fuel Injection in Response to Fuel Type

(76) Inventor: Paul Spivak, Mayfield Heights, OH (US)

Correspondence Address: PATENT, COPYRIGHT & TRADEMARK LAW GROUP, 4199 Kinross Lakes Parkway, Suite 275, RICHFIELD, OH, 44286, US

(21) Appl. No.: 12/100,827

(22) Filed: Apr. 10, 2008

Related U.S. Application Data
(60) Provisional application No. 60/910,927, filed on Apr. 10, 2007.

(51) Int. Cl. F02D 41/30

(52) U.S. Cl. 701/103

(57) ABSTRACT

An engine control unit is configured to provide a fuel injector pulse width signal. A signal modifier comprises a fuel-type identifier in communication with the engine control unit. The signal modifier is configured to provide a 25% greater, modified pulse width signal to the fuel injector component in response to a parameter input to the fuel-type identifier. The pulse width signal is optimized for a gasoline blend and, more particularly, to an E85 fuel blend.

### RELATED APPLICATIONS

The present application is a Continuation-in-Part of U.S. Ser. No. 60/910,927 and it claims a priority to the provisional's Apr. 10, 2007 filing date. The present application incorporates the subject matter disclosed in ('927) as if it is fully rewritten herein.

### BACKGROUND OF THE INVENTION

### 1. Field of the Invention

The present invention relates to systems for the controlled combusting of fuels, and, more particularly, to internal combustion engine systems configured to operate on multiple types of fuel.

### SUMMARY OF THE INVENTION

In an internal combustion engine fuel is ignited and burned in a combustion chamber, wherein an exothermic reaction of the fuel with an oxidizer creates gases of high temperature and pressure. The pressure of the expanding gases directly act upon and cause a corresponding movement of pistons, rotors, or other elements, which are operationally engaged by a one or transmission systems to translate the element movement into working or motive forces.

The most common and important application of the internal combustion engine is the automobile, and due to its high energy density, relative availability and fully developed supply infrastructure, the most common fuels used in automobile engines in the United States of America and throughout the world are petroleum-based flues, namely, gasoline and diesel fuel blends; however, a reliance upon petroleum-based fuels generates carbon dioxide, and the operation of millions of automobiles world-wide results in the release of a significant total amount of carbon dioxide into the atmosphere, wherein the scale of the amount generated is believed to contribute to global warming.

The petroleum acquisition and transportation operations associated with producing automotive fuels for the world also result in significant social and environmental impacts. For example, petroleum drilling and transportation discharges and by-products frequently cause significant harm to natural resources. The limited and unequal geographic distribution of significant sources of petroleum within a relatively small number of nations renders large consuming nations (such as the United States) net-importers dependent upon nations and sources outside of domestic political control, which has exasperated or directly resulted in international conflicts, social unrest and even warfare in many regions of the world.

One solution is to reduce the conventional automobile's reliance on petroleum-based fuel by substituting one or more economically and socially feasible alternative fuels, energy sources or motive energy systems. Many types of alternative fuels are available or have been proposed for use with internal combustion engines, including gasoline-type biofuels such as E85 (a blend of 15% gasoline and 85% ethanol) and P-series fuels, and diesel-type biofuels such as hempseed oil fuel or other vegetable oils. Alternative power systems (illustrative but not exhaustive examples include hydrogen combustion or fuel-cell systems, compressed or liquefied natural gas or propane gas systems, and electric motor systems) may also replace an internal combustion engine or be used in combination therewith in a “hybrid” system.

However, the costs of adopting alternative fuels or power systems on a large scale are significant. In particular, the investment required to build an infrastructure necessary to support any one of the alternative fuels or power systems on a scale that will enable a migration away from the internal combustion gasoline or diesel engine is prohibitively large. Accordingly, at present, alternative fuel or power system automobiles make up only a very small fraction of the world's automobiles. A more cost-effective approach is to modify existing conventional internal combustion automobiles and support infrastructures to replace petroleum-based fuels with one or more alternative fuels.

However, conventional internal combustion gasoline or diesel engines are designed to operate on fuel specifications that severely limit the possibilities of using alternative fuels on a large and meaningful scale. Known alternative fuel blends diverge greatly from conventional petroleum-based fuel specifications, and thus replacing a petroleum fuel blend with an alternative fuel requires significant reconfiguration of engine systems, and more particularly engine ignition and fuel supply systems. And once reconfigured, the altered systems can no longer acceptably function with conventional gasoline blends. Thus the owner or operator of a conventional automobile must choose between relying on a ubiquitous petroleum fuel, readily available through a huge well-developed fuel production and supply system, or reconfigure his automobile to run instead on an alternative fuel. The latter may be difficult to obtain and it may have uncertain future supply and pricing characteristics; however, switching back to the petroleum fuel blend at some future point will result in service costs and inefficiencies.

Thus what is needed is a method or system that addresses the problems discussed above, as well as others, s.a., e.g., enabling a conventional automobile to efficiently use both conventional petroleum fuel blends and alternative blends.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 illustrates a portion of a conventional PRIOR ART automobile fuel injector system;

FIG. 2 illustrates portions of an automobile fuel injector system in accordance with a preferred embodiment of the present invention; and,

FIG. 3 is a schematic illustration of a computer system of the present invention;

wherein the drawings are not necessarily to scale. The drawings are merely schematic representations not intended to portray specific parameters of the invention. The drawings are intended to depict only typical embodiments of the invention, and therefore they should not be considered as limiting the scope.

### DESCRIPTION OF THE PREFERRED EMBODIMENTS

### 1. Detailed Description of the Figures

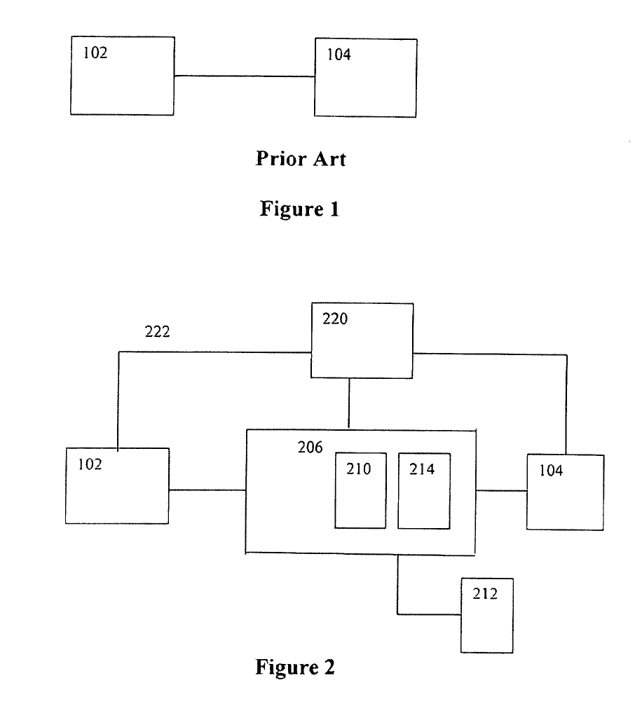

Referring now to FIG. 1, a gasoline internal combustion engine control unit (ECU) 102 is shown in communication with and configured to control a conventional automobile fuel injector component 104. The ECU 102 may also control other automobile systems, for example, ignition timing and transmission systems (not shown) and in some examples it may be referred to as an Engine Control Module (ECM) or a Powertrain Control Unit/Module (PCU, PCM). The fuel injector component 104 comprises a plurality of electronically controlled valves with at least one valve provided for each engine cylinder. The valves are each supplied with pressurized fuel by a fuel pump (not shown). The valves are configured to open and close many times per second, and the amount of fuel supplied to the engine is determined by the amount of time the fuel injector stays open. The length of time is called the “pulse width” and it is controlled by ECU 102 pulse width signals.

The ECU 102 pulse width signals control the amount and rate of fuel injected into each engine combustion chamber, thereby controlling the combustion chamber air-fuel ratio (AFR). The AFR is the mass ratio of air to fuel present during combustion. When all the fuel is combined with all the free oxygen within the combustion chamber, the mixture is chemically balanced and this AFR is called the stoichiometric mixture, which is ignited by the automobile ignition system in a timing coordination with cylinder head positioning and anticipated time of ignition and combustion. Each fuel has a preferred AFR or range of AFRs which will achieve optimal fuel combustion when ignited, and which is dependent in part on the amount of hydrogen and carbon found in a given amount of fuel. AFRs below preferred value(s) result in a rich mixture, wherein unburned fuel is left over after combustion and exhausted, wasting fuel and creating pollution. Alternatively, AFRs above preferred value(s) result in a lean mixture having excess oxygen, which tends to produce more nitrogen-oxide pollutants and can cause poor performance and even engine damage.

The ECU 102 monitors the mass of air entering the engine, the amount of oxygen in the exhaust and other engine system performances and uses, one or more formula (s) and a large number of lookup tables to determine the pulse width for a given operating condition, avoiding too-rich and too-lean AFRs by increasing or decreasing fuel injector 104 pulse widths in real-time in a closed-loop control system. The ECU 102 generally computes more than 100 parameters, each having its own lookup table, and some of the parameters even change over time in order to compensate for changes in the performance of engine components, s.a., e.g., a catalytic converter. Depending on the engine speed, the ECU 102 performs these calculations over a hundred times per second.

Problems arise if the ECU 102 is sued with alternative fuels. For example, E85 fuel combustion generates lower energy as measured in British Thermal Units (BTUs) than gasoline fuel blends and thus higher pulse widths are required to generate comparable engine performances under similar operating parameters. And reconfiguring the ECU 102 to produce appropriate pulse width signals for more than one anticipated fuel blend is not practical in view of the complex computational demands placed upon the limited available ECU 102 processor resources for even one fuel type.

FIG. 2 provides an alternative fuel injector control system according to the present invention, wherein a Pulse Modifier 206 is provided interposed between the ECU 102 and the fuel injector component 104. The Pulse Modifier 206 modifies the ECU 102 pulse width signals to enable the fuel injectors 104 to efficiently operate on one or more alternative fuels. The Pulse Modifier 206 may be programmed or otherwise configured by a manufacturer, an after-market retailer or installer, or by some other service provider. It may also be subsequently re-programmed as required to provide optimal fuel injector settings for one or more specified alternative fuels.

The Pulse Modifier 206 is configured to actively detect alternative fuel parameters and automatically modify the ECU 102 fuel injector pulse width signals and send the modified pulse width signals to the fuel injectors 104 without all owner/operator input requirements, and wherein the modified pulse width signals are configured to optimize engine performance for an alternative fuel. Thus a conventional automobile incorporating the Pulse Modifier 206 is enabled to use conventional gasoline or one or more alternative fuels. The Pulse Modifier 206 automatically switches between conventional and alternative fuel modes in response to monitoring one or more automobile system parameters.

In an example illustrated in FIG. 2, the Pulse Modifier 206 comprises at least one fuel-type identifier 210. When a conventional gasoline blend is used by the automobile engine, the detector component 212 sends a gasoline identifier parameter to the fuel-type identifier 210, which causes the Pulse Modifier 206 to stay or change into a passive or inactive mode. The Pulse Modifier 206 passes the ECU 102 pulse width signals directly to the fuel injectors 104 without modification. Alternatively, when E85 is used for the automobile engine, the detector component 212 sends a parameter associated with E85 to the fuel-type identifier 210, which activates the Pulse Modifier 206, which modifies the ECU 102 pulse width signals as discussed above (e.g., by widening the pulse widths by 25%). Modified pulse width signals are sent to the fuel injectors 104.

The detector 212 may make the fuel type determination itself directly from observing one or more system inputs. In one embodiment, the detector component 212 is a fuel-line sensor 212 which observes one or more fuel parameters (s.a., fuel resistance, capacitance or some other electrical characteristic) for a threshold value(s) and sends either gasoline or E8 parameters to the fuel-type identifier 210 based on relation to the threshold values.

One or more automobile system components 220 may also function to provide fuel-type parameter inputs directly to the fuel-type identifier 210 from the ECU 102, the fuel injectors 104 or from some other engine or automobile system component. Thus, some embodiments may omit the detector 212. In one embodiment, an exhaust oxygen sensor 220 output functions as a fuel-type parameter input. The fuel-type identifier 210 identifies a fuel type based upon comparison of an observed richness or leanness of engine system operation to a threshold value. For example, if the oxygen sensor 220 reports richness or leanness observations outside of expected leanness/richness thresholds for an expected fuel-type given the ECU 102 pulse width signals provided, then a different type of fuel has been detected and the fuel-type identifier 210 operates the switch to activate the Pulse Modifier 206 to generate modified pulse width signals appropriate to the detected fuel. In another embodiment, an Onboard Diagnostic System (OBD) port 220 provides inputs to a fuel-type identifier 210 configured to recognize a fuel type being used by the engine based upon the OBD port 220 outputs.

Pulse width modifications may also be further fine-tuned through additional feedback inputs into a performance monitor component 214. In one example, oxygen sensor and/or OBD 220 outputs are further monitored against one or more additional thresholds for performance quality through a closed-control loop, wherein the amount or degree of pulse width signal modification is varied until as needed until performance quality threshold(s) are met. Thus, in a first step the fuel-type identifier 210 activates the Pulse Modifier 206 to modify the ECU 102 pulse width signals, and then the amount/degree of signal modification is fine tuned by the performance monitor 214 until acceptable or even optimized engine performance is achieved.

External component 220 inputs may also be provided by an external service provider 220, wherein behavior of one or more of the fuel injector component 104, ECU 102, Pulse Modifier 206 and/or other engine or automobile components may be monitored and parameters provided to either or both of the fuel-type identifier 210 and performance Monitor 210, thereby to select a fuel-type mode (e.g., activating or de-activating the Pulse Modifier 206) and/or fine tune the amount of pulse width modification.

Monitoring may be performed locally or remotely through a communication network 222, wherein illustrative examples include the internet, a local area network (LAN), a wide area network (WAN), Bluetooth® network communications and/or cellular network communications (such as OnStar® network communications). The service provider 220 may thus perform or offer to perform monitoring, Pulse Modifier 206 adjustment and/or maintenance services on a subscription basis to an automobile owner or operator.

Thus the Pulse Modifier 206 may be easily incorporated into a conventional automobile and enable the automobile to seamlessly operate on either conventional fuel (gasoline or diesel) or one or more alternative fuels (E85, bio-diesel alternatives, etc.) by automatically changing fuel injector pulse widths as needed without an required owner/operator inputs or actions. By passing conventional fuel injector settings from the ECU 102 unimpeded and directly to fuel injectors 104, the Pulse Modifier 206 has no impact on conventional fuel use and operations, and thus no adverse impact on automobile performance. Switching back and forth between fuel types does not require expensive and time-inefficient servicing of the automobile, as is commonly required in configuring a conventional automobile to utilize alternative fuels.

The Pulse Modifier 206 output thus comprises modified ECU 102 pulse width signals: in one example for E85 fuel the Pulse Modifier 206 expands the pulse width signal width by about 25%. In other examples, the Pulse Modifier 206 adds a constant to an ECU 102 pulse width signal, and in still other examples an amplification algorithm is configured to replace ECU 102 pulse width signals and provide independently-determined pulse width signals to the fuel injectors 104.

### 2. Computerized Implementation

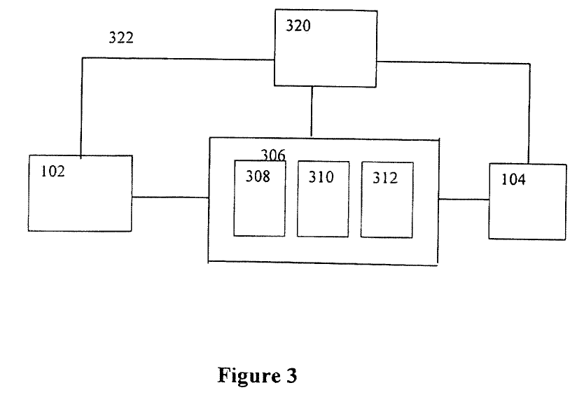

Referring now to FIG. 3, an exemplary computerized implementation of an alternative fuel injection control system according to the present invention is provided as described generally above, wherein a Pulse Modifier processing unit 306 is shown in communication through a network computer infrastructure 322 with the ECU 102 and the fuel injector component 104. This is intended to demonstrate, among other things, that the present invention could be implemented within a network environment (e.g., the Internet a wide area network (WAN), a local area network (LAN), a virtual private network (VPN), etc.), or on a stand-alone computerized electronic ignition system. In the case of the former, communication throughout the network can occur via any combination of various types of communications links. For example, the communication links can comprise addressable connections that may utilize any combination of wired and/or wireless transmission methods.

Where communications occur via the Internet, connectivity could be provided by conventional TCP/IP sockets-based protocol. An Internet service provider could be used to establish connectivity to the Internet. Still yet, the computer infrastructure 322 is intended to demonstrate that some or all of the components of a local client application implementation could be deployed, managed, serviced, etc. by a service provider who offers to implement, deploy and/or perform the functions of the present invention for others.

A wide variety of terminal devices 320 may be practiced with the present invention, illustratively including local computers, personal digital assistants (PDAs) and cellular telephones; however, it is to be understood that the present invention is not limited to these specific examples and embodiments discussed herein. Other types of terminal devices 320 may be appropriate for use with the present invention, some of which may be apparent to one skilled in the art.

As shown, Pulse Modifier processing unit 306 includes a processing unit 312, a memory 310 and an input/output (I/O) interface 308. In general, the processing unit 312 executes computer program code, such as the code to implement the recognition of fuel types and/or responsive selection of fuel injector control signal outputs, which is stored in the memory 310 or received from the I/O interfaces 308. It is to be appreciated that two or more, including all, of these components may be implemented as a single component structure.

While executing computer program code, the processing unit 316 can read and/or write data to/from the memory 310 and/or the I/O interfaces 308. The external device 320 can comprise any device (e.g., keyboard, pointing device, display, etc.) that enables a user to interact with the Pulse Modifier processing unit 306 and/or any devices (e.g., network card, modem, etc.) that enables the Pulse Modifier processing unit 306 to communicate with one or more other computing devices.

The computer infrastructure 306 is only illustrative of various types of computer infrastructures for implementing the invention. For example, in other embodiments, the Pulse Modifier processing unit 306 can comprise any specific purpose computing article of manufacture comprising hardware and/or computer program code for performing specific functions, any computing article of manufacture that comprises a combination of specific purpose and general purpose hardware/software or the like. In each case, the program code and hardware can be created using standard programming and engineering techniques, respectively.

Moreover, Pulse Modifier processing unit 306 may comprise a single processing unit, or be distributed across one or more processing units in one or more locations, e.g., on a client and server. Similarly, the memory 316 can comprise any combination of various types of data storage and/or transmission media that reside at one or more physical locations. Further, the I/O interface 324 can comprise any system for exchanging information with one or more of the external devices 320. Still further, it is understood that one or more additional components (e.g., system software, math coprocessing unit, cache memory, communication systems, etc.) (not shown) in FIG. 3 can be included in the Pulse Modifier processing unit 306.

While shown and described herein as methods and systems for implementing the recognition of fuel types and/or responsive selection of fuel injector control signal outputs., it is understood that the invention further provides various alternative embodiments. For example, in one embodiment, the invention provides a computer-readable/usable medium 310 that includes computer program code to enable a computer infrastructure to provide recognition of fuel types and/or responsive selection of fuel injector control signal outputs. To this extend, the computer-readable/usable medium includes program code that implements each of the various process stems of the invention.

It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 310 (e.g., a fixed disk, a read-only memory, a random access memory, a cache memory, etc.), and/or as a data signal (e.g., a propagated signal) traveling over a network 322 (e.g., during a wired/wireless electronic distribution of the program code) and made available through the I/O interfaces 312).

In another embodiment, the invention provides a business method that performs the process steps of the invention on a subscription, advertising, and/or fee basis. That is, a service provider could offer to manage implementation of recognition of fuel types and/or responsive selection of fuel injector control signal outputs through the components and steps described above. In this case, the service provider can create, maintain, and support, etc., a computer infrastructure, s.a., the computer infrastructure 306 and/or 320 that performs the process steps for the invention for one or more customers. In return, the service provider can receive payment from the customer(s) under a subscription and/or fee agreement. The service provider can alternatively or additionally receive payment from the sale of advertising content to one or more third parties.

In still another embodiment, the invention provides a computer-implemented method for implementing the recognition of fuel types and/or responsive selection of fuel injector pulse width signals described above. In this case, a computer infrastructure, such as the computer infrastructure 306 and/or 320, can be provided and one or more systems for performing the process steps of the invention can be obtained (e.g., created, purchased, used, modified, etc.) and deployed to the computer infrastructure. To this extend, the deployment of a system can comprise one or more of: (1) installing program code on a computing device, such as the computer system 306 and/or 320, from a computer-readable medium 310; (2) adding one or more computing devices to the computer infrastructure; and, (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extend, program code can be embodied as one or more of an application/software program, component software/library of functions, an operating system, a basic 110 system/driver for a particular computing and/or I/O device, and the like.

The foregoing descriptions of specific embodiments of the present invention are presented for purposes of illustration and description. They are not intended to be exhaustive nor to limit the invention to the precise forms disclosed and, obviously, many modifications and variations are possible in light of the above teaching. For example, alternative fuels practiced by the present invention are not limited to E85 fuels, and other alternative fuels may be practiced. Illustrative examples include P-series fuels, diesel-type biofuels such as hempseed oil fuel or other vegetable oils, liquified natural gas, hydrogen fuels, though others may be appropriate as understood by those in the art. Such modifications and variations that may be apparent to a person skilled in the art are intended to be included within the scope of the invention as defined by the accompanying claims.

Still yet, any of the components of the present invention could be deployed, managed, serviced, etc., by a service provider who offers to manage fuel injector settings through the components and steps described above. In another embodiment, the invention provides a business method that performs the process steps of the invention on a subscription, advertising and/or fee basis. In this case, the service provider can create, maintain, and support, etc., a computer infrastructure, s.a., the computer infrastructure 220 that performs the process steps of the invention, for one or more customers. In return, the service provider can receive payment from the customer(s) under a subscription and/or fee agreement and/or the service provider can receive payment from the sale of advertising content to one or more third parties.

Having thus described the invention what is claimed as new and desired to be secured by Letters Patent is as follows:

1. A system, comprising:
an engine control unit configured to provide a fuel injector pulse width signal;
a signal modifier in communication with the engine control unit and comprising a fuel-type identifier, the signal modifier configured to modify the pulse width signal to generate a modified pulse width signal; and,
a fuel injector component in communication with the signal modifier;
wherein the signal modifier is configured to provide the pulse width signal or the modified pulse width signal to the fuel injector component in response to a parameter input to the fuel-type identifier.

2. The system of claim 1, wherein the pulse width signal is optimized for a gasoline blend, and wherein the modified pulse width signal is optimized for an E85 fuel blend.

3. The system of claim 1, wherein the modified pulse width signal is about 25% greater than the pulse width signal.

4. The system of claim 2, wherein the signal modifier further comprises a performance monitor component configured to increase or decrease an amount of pulse width modification in response to a performance parameter.

5. The system of claim 4, further comprising a service provider in communication with at least one of the engine control unit, the signal modifier and the fuel injector component, the service provider configured to monitor the at least one of the engine control unit, the signal modifier and the fuel injector component and provide a notification of an event occurrence.

6. The system of claim 5, wherein the notification is at least one of the input parameter and the performance parameter.

7. The system of claim 3, wherein the signal modifier further comprises a performance monitor component configured to increase or decrease an amount of pulse width modification in response to a performance parameter.

8. The system of claim 7, further comprising a service provider in communication with at least one of the engine control unit, the signal modifier and the fuel injector component, the service provider configured to monitor the at least one of the engine control unit, the signal modifier and the fuel injector component and provide a notification of an event occurrence.

9. The system of claim 8, wherein the notification is at least one of the input parameter and the performance parameter.

10. A method, comprising the steps of:
generating a pulse width signal optimized for a first fuel;
modifying the pulse width signal to generate a modified pulse width signal in response to an input parameter; and
providing the pulse width signal or the modified pulse width signal to a fuel injector operating with the identified fuel in response to a parameter input.

11. The method of claim 10, further comprising the step of identifying a second fuel presence from the parameter input.

12. The method of claim 11, further comprising the steps of:
optimizing the pulse width signal for gasoline blend; and
optimizing the modified pulse width signal for an E85 fuel blend.

13. The method of claim 11, wherein the step of modifying the pulse width signal comprises widening the pulse width signal by a widening factor.

14. The method of claim 13, wherein the step of modifying the pulse width signal comprises widening the pulse width signal by about 25%.

15. The method of claim 12, further comprising the steps of:
monitoring an engine system component for a performance parameter; and,
increasing or decreasing an amount of pulse width modification in response to the performance parameter.

16. The method of claim 15, further comprising the steps of:
a service provider monitory at least one of an engine control unit configured to generate the pulse width signal, a signal modifier configured to generate the modified pulse width signal and a fuel injector component; and
the service notifying at least one of an engine control unit event occurrence, a signal modifier event occurrence and a fuel injector component event occurrence.

17. The method of claim 16, wherein the step of notifying comprises outputting at least one of the input parameter and the performance parameter.

18. The method of claim 13, further comprising the steps of:
monitoring an engine system component for a performance parameter; and,
increasing or decreasing an amount of pulse width modification in response to the performance parameter.

19. The method of claim 18, further comprising the steps of:
a service provider monitory at least one of an engine control unit configured to generate the pulse width signal, a signal modifier configured to generate the modified pulse width signal and a fuel injector component; and
the service notifying at least one of an engine control unit event occurrence, a signal modifier event occurrence and a fuel injector component event occurrence.

20. The method of claim 19, wherein the step of notifying comprises outputting at least one of the input parameter and the performance parameter.
